(19) United States
(12) Patent Application Publication
(10) Pub. No.: US 2008/0026714 A1
(43) Pub. Date: Jan. 31, 2008

(54) Battery pack incorporated with keys

(76) Inventor: Robert W. DiGiovanna, Shirley, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/496,323

(22) Filed: Jul. 31, 2006

(51) Int. Cl. H04B 1/18

(52) U.S. Cl. 455/187.1

(57) ABSTRACT

Manually depressible keys are incorporated in a battery pack to reduce the overall height of an electrical assembly mounted in a battery-powered, key-operated, device.

### DESCRIPTION OF THE RELATED ART

Batteries are used to provide power to many electronic devices, typically portable or mobile devices, especially those operated by a keypad, for example, cellular telephones, data capture terminals, laptop and notebook computers, video recorders, cameras, and so forth. Cells used in such batteries include lithium-ion, nickel-cadmium, nickel metal hydride, lithium-polymer, alkaline, acid, zinc, etc.

Typically, a group of rechargeable batteries are electrically interconnected and encased in a plastic-molded pack. A battery printed circuit board (PCB) is contained in the pack, and electronics are mounted on the battery PCB. The electronics may include an integrated circuit for protection, a monitor for monitoring the state of the pack and for providing access to an external unit, a temperature sensor, etc.

The pack is typically mounted on one side of a main PCB within a device, and the keypad is typically mounted on an opposite side of the main PCB. If other electrical components are provided, such as a display or a communications transceiver, then these other components are mounted on the same side of the main PCB as the keypad. As advantageous as this construction is, the result is a rather thick, bulky electrical assembly which, in turn, causes the device to be of large size and unwieldy.

### SUMMARY OF THE INVENTION

One feature of the present invention resides, briefly stated, in a battery pack comprising a battery, a casing for containing the battery, a battery printed circuit board (PCB) within the casing, and at least one manually depressible key and, preferably, a plurality of such keys mounted on the battery PCB and incorporated with the battery pack. Since each key is incorporated with the battery pack, the key-incorporated battery pack can be mounted on the same side of a main PCB of an electrical device as other electrical components. For example, in the event that the electrical device is a communications device such as a telephone, the electrical components mounted on the same side of the main PCB as the key-incorporated battery pack may include a display and a transceiver, all of which together comprise an assembly. The opposite side of the main PCB no longer supports a conventional battery pack. Thus, the overall height, as considered in a direction perpendicular to the main PCB, of the assembly according to this invention is less than heretofore since all the electronic components are located on only one side of the main PCB, and not on both sides thereof. When the reduced-height assembly is placed in a housing of the device, the housing can be smaller and streamlined, thereby rendering the device less bulky and more manageable.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side sectional view of an electrical assembly in a device according to the prior art;

FIG. 2 is a view analogous to FIG. 1 according to the invention; and

FIG. 3 is a perspective view of a key-incorporated battery pack for use in the assembly of FIG. 2.

### DETAILED DESCRIPTION OF THE PREFERRED EMBODIMENTS

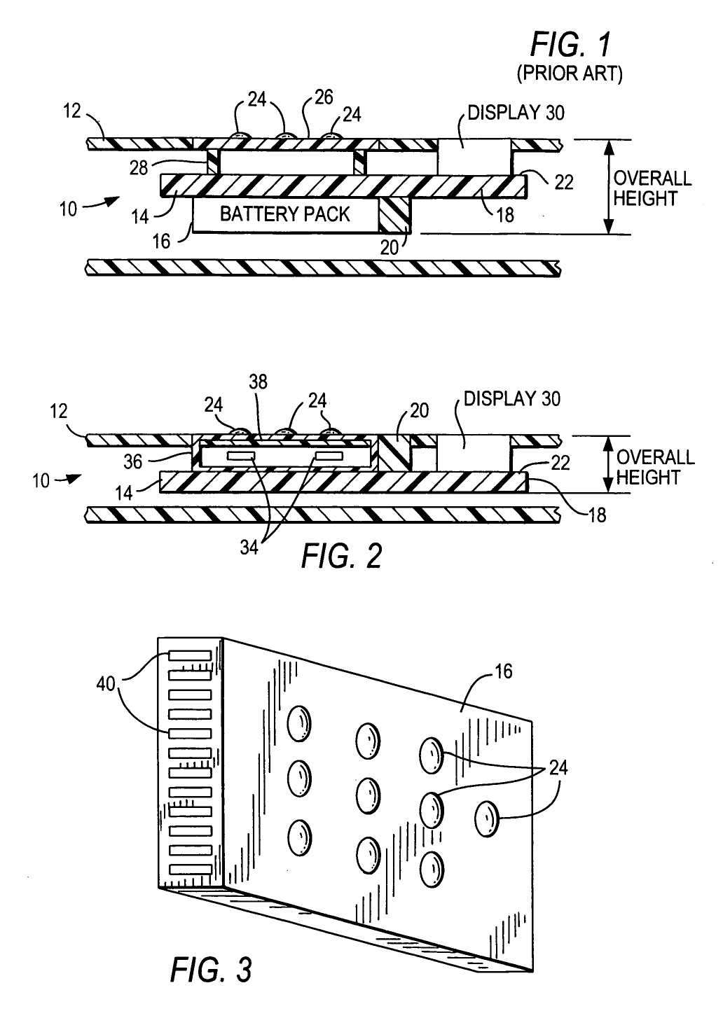

Reference numeral 10 in FIG. 1 generally identifies an electrical assembly mounted in a portable, battery-powered, key-operated device 12, such as a cellular telephone, a data capture terminal, a laptop/notebook computer, a video recorder, a camera, etc. in accordance with the prior art. A main printed circuit board (PCB) 14 is mounted in the device 12. A battery pack 16 is mounted on a bottom side 18 of the main PCB 14 and is electrically connected by external contacts with a connector 20, also mounted on the bottom side 18.

On a top side 22 of the main PCB 14, a plurality of keys 24 comprising a keypad is mounted on a keypad PCB 26 which, in turn, is supported by a keypad frame 28 on the top side 22. Other electrical components, such as a display 30, are also mounted on the top side 22.

As depicted in FIG. 1, the overall height of the assembly 10, as considered in a direction perpendicular to the main PCB 14, is the combined height of the components on the top side 22 and of the components on the bottom side 18. An object of this invention, as depicted in FIG. 2, is to reduce the overall height. Thus, as shown in FIG. 2, there are no components on the bottom side 18, and the overall height is reduced as compared to that shown in FIG. 1.

In accordance with this invention, at least one of the keys 24 and, preferably, a plurality of the keys 24 is incorporated in a battery pack 32 which comprises at least one battery 34, a casing 36 for containing the battery 34 and a battery PCB 38. Rather than mounting each key 24 on the keypad PCB 26, each key 24 is mounted on the battery PCB 38. The keypad PCB 26 and the keypad frame 28 have been eliminated.

As shown in FIG. 3, the battery pack 32 has external contacts 40 for connection to the connector 20 which is now mounted on the top side 22. These external contacts 40 conduct battery signals, as well as keypad signals.

Since the bottom side 18 no longer supports the battery pack, the main PCB can be placed very close to a housing wall for the device, thereby enabling the housing to be miniaturized. When the battery pack is removed, for example, for recharging, the keypad is also removed. This allows alternate or custom keypads to be designed and installed in the device. The installed keypad can be automatically detected by software. For example, one keypad can be a full numeric keypad for dialing numbers, and another keypad can be a full alphanumeric keypad or a simple push-to-talk/volume control keypad.

It will be understood that each of the elements described above, or two or more together, also may find a useful application in other types of constructions differing from the types described above.

While the invention has been illustrated and described as embodied in a battery pack incorporated with keys, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

I claim:

1. A battery pack, comprising:
a) a battery;
b) a casing for containing the battery;
c) a battery printed circuit board (PCB) within the casing; and
d) at least one manually depressible key mounted on the battery PCB and incorporated with the battery pack.

2. The battery pack of claim 1, and additional manually depressible keys mounted on the battery PCB.

3. The battery pack of claim 1, wherein the battery PCB and the battery are encased within the casing.

4. The battery pack of claim 1, and a plurality of external contacts on the casing for conducting electrical signals from the battery and the key.

5. An electrical assembly, comprising:
a) a main printed circuit board (PCB) having a top side and a bottom side; and
b) a plurality of electrical components mounted on only one of the sides of the main PCB, one of the components comprising a battery pack including a battery, a casing for containing the battery, a battery PCB within the casing, and at least one manually depressible key mounted on the battery PCB and incorporated with the battery pack.

6. The assembly of claim 5, wherein another of the components is a display.

7. The assembly of claim 5, and additional manually depressible keys mounted on the battery PCB.

8. The assembly of claim 5, wherein the battery PCB and the battery are encased within the casing.

9. The assembly of claim 5, and a plurality of external contacts on the casing for conducting electrical signals from the battery and the key.

10. A battery-powered, key-operated, electrical device, comprising:
a) a housing;
b) a main printed circuit board (PCB) in the housing and having a top side and a bottom side; and
c) a plurality of electrical components mounted on only one of the sides of the main PCB, one of the components comprising a battery pack including a battery, a casing for containing the battery, a battery PCB within the casing, and at least one manually depressible key mounted on the battery PCB and incorporated with the battery pack.

11. The device of claim 10, wherein another of the components is a display.

12. The device of claim 10, and additional manually depressible keys mounted on the battery PCB.

13. The device of claim 10, wherein the battery PCB and the battery are encased within the casing.

14. The device of claim 10, and a plurality of external contacts on the casing for conducting electrical signals from the battery and the key.

15. The device of claim 10, wherein the housing is a telephone housing.

16. A battery pack, comprising:
a) battery means for supplying electrical power;
b) casing means for containing the battery means;
c) battery printed circuit board (PCB) means within the casing means; and
d) at least one manually depressible key means mounted on the battery PCB means and incorporated with the battery pack.

17. A method of incorporating at least one manually depressible key with a battery pack, comprising the steps of:
a) containing a battery in a casing;
b) mounting a battery printed circuit board (PCB) within the casing; and
c) mounting the at least one key on the battery PCB.

18. The method of claim 17, and mounting additional manually depressible keys on the battery PCB.

19. The method of claim 17, and encasing the battery PCB and the battery in the casing.

20. The method of claim 17, and conducting electrical signals from the battery and the key through contacts located externally of the casing.
